(19) United States
(12) Patent Application Publication
(10) Pub. No.: US 2003/0005786 A1
(43) Pub. Date: Jan. 9, 2003

(54) Parallel mechanism

(75) Inventors: J. Michael Stuart, Corrales, NM (US); Steve T. Charles, Germantown, TN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MicroDexterity Systems, Inc., Albuquerque, NM

(21) Appl. No.: 10/187,932

(22) Filed: Jul. 2, 2002

Related U.S. Application Data
(60) Provisional application No. 60/303,153, filed on Jul. 5, 2001.

(51) Int. Cl. G05G 11/00

(52) U.S. Cl. 74/479.01; 74/490.08

(57) ABSTRACT

A parallel mechanism for manipulating an object in space is provided. The parallel mechanism includes an end platform for supporting an object to be manipulated and an intermediate platform arranged in spaced relation from the end platform and connected to the end platform by a connecting element. A plurality of first links are connected to the end platform and a plurality of second links are connected to the intermediate platform. A linear motor is associated with each first link and each second link for translating the ends of the first and second links to move the end and intermediate platforms.

### CROSS-REFERENCE TO RELATED PATENT APPLICATIONS

This patent application claims the benefit of U.S. Provisional Patent Application Serial No. 60/303,153.

### FIELD OF THE INVENTION

The present invention relates to manipulators and, more particularly, to multiple degree-of-freedom (DOF) parallel manipulators.

### BACKGROUND OF THE INVENTION

The vast majority of multiple degree-of-freedom mechanisms that are used in robotic or teleoperator applications are so-called serial mechanisms. A serial mechanism is one in which a plurality of links are connected together in series to form an open chain and are moved with respect to each other by actuators connected between them to manipulate an object supported at the remote end of the chain of links. This type of mechanical mechanism has the advantages of the ability to access large workspaces, and of simplicity of design and geometric analysis. It has been shown that the forward kinematic problem is always directly solvable for serial mechanisms. The forward kinematic problem is defined as the task of solving for the position and orientation of the remote end of the mechanism on which a tool is mounted, given the lengths of all of the links and the angles between adjoining links.

Despite the above mentioned advantages, serial mechanisms are inherently plagued with a number of disadvantages. For one, the links at the base of a serial mechanism must support all of the more remote links of the mechanism. As a result, large actuators are required to drive the actuated joints at the base of the mechanism. For precise control, it is advantageous to have an actuator as close as possible to the tool or other object being driven by the actuator. With a serial mechanism, having an actuator close to the object being driven compromises the overall performance of the mechanical system, since actuators are typically heavy electric motors. In the case of a robotic wrist, for example, the designer must choose between locating the actuators that drive the robotic wrist directly at the wrist joints, and locating the wrist actuators towards the base of the robot and using a complex series of cables, gears, or other transmission devices to connect the wrist actuators to the wrist joints. The former choice allows precise control of the wrist but also requires that elbow and shoulder actuators located closer to the base support these wrist actuators, resulting in a large load being applied to the elbow and shoulder actuators. The latter choice reduces the moving mass which the elbow and shoulder actuators of the robot must support, but it also introduces numerous potential sources of error in the control of the position and/or force of the wrist, including backlash, friction, and wear. Another problem of serial mechanisms occurs when the position of the mechanism remote from a support structure is determined by sensors, such as encoders, which are located at the joints of the mechanism and measure the angles between adjoining links. Errors in measurement by the encoders are cumulative, i.e., the error in the calculated position of the remote end of the mechanism is a sum of errors of the individual encoders, so it is difficult to determine the position of the remote end with accuracy. Even when there is no encoder error, calculation of the position of the remote end may be inaccurate due to bending of the links forming the serial mechanism. These problems occur not just with robotic wrists but with serial mechanisms in general.

Another variety of multiple degree-of-freedom mechanism is referred to as a parallel mechanism. In parallel mechanisms, a plurality of actuators drive a tool or other object in “parallel”, typically via a plurality of stiff links and joints. The term parallel in this sense means that the links share the load being supported by the mechanism, and it does not require that the links be geometrically parallel or imply that they are. Parallel mechanisms are inherently stiffer, quicker, more accurate, and capable of carrying higher loads than serial mechanisms. This is because parallel mechanisms have multiple mechanical ties between a base support structure and the object being supported so that the weight of the object is divided among a plurality of members, whereas in serial mechanisms, each link must support the entire weight of the object. A parallel mechanism typically has all of its actuators mounted either on or relatively close to a base support structure, so the actuators either do not move or move very little during the operation of the mechanism. This minimizes the moving mass of the mechanism, making it much quicker than an equivalent serial mechanisms. Furthermore, since the entire load carried by the mechanism is not applied to each actuator as in a serial mechanism but is distributed among the actuators, the load capacity of the mechanism can be greatly increased relative to that of a serial mechanism without requiring large capacity (and thus bulky and heavy) actuators. In addition, errors in encoders or other sensors for sensing the position or orientation of the links forming a parallel mechanism are averaged rather than summed as in a serial mechanism, so the position and orientation of a load can be determined with high accuracy. A parallel mechanism is akin to a truss or space frame-type structure in which a load is supported by multiple paths to ground rather than by a single path. A mechanism is considered fully parallel if it has no actuators connected in series.

In spite of such advantages, parallel mechanisms have not achieved widespread acceptance as robotic or teleoperated devices due to a number of drawbacks. One is that conventional parallel mechanisms have limited reachable workspaces compared to serial mechanisms, so they are limited to tasks which do not require large workspaces. This is in part because parallel mechanisms have multiple mechanical ties to a fixed support structure whereas serial mechanisms have only one, and in part because the parallel links of a parallel mechanism can interfere with one another in certain positions. In addition, the forward kinematics problem for a parallel mechanism can be extremely complex mathematically, and in many cases it is not solvable, often making real time control of a parallel mechanism difficult or impossible.

Aside from the above problems, both parallel and serial mechanisms of conventional design tend to suffer from backlash in the components, relatively high friction, a narrow operational bandwidth, and high inertia which make high positional resolution and highly sensitive force control difficult to achieve.

### SUMMARY OF INVENTION

The present invention provides a parallel manipulator or mechanism for robotic or teleoperator (master/slave) applications which can operate with six or more degrees of freedom and which can overcome many of the disadvantages of known parallel manipulators.

A parallel manipulator according to the present invention is capable of having a high mechanical bandwidth, a low inertia, a high dexterity, and low frictional resistance, all of which combine to enable it to operate with a high degree of position and force control unattainable by conventional serial or parallel mechanisms.

A parallel manipulator according to the present invention can be used in any application in which an object needs to be manipulated in space with one or more degrees of freedom. A few examples of possible applications in various fields are as follows.

Industrial Applications

A parallel mechanism according to the present invention can be used as a general purpose manipulator or a robotic arm for manipulating any desired device in an industrial application, including parts to be assembled, workpieces being processed, manufacturing tools (cutting tools, welding tools, sensors, painting equipment, etc.), and sensors (cameras, distance sensors, movement sensors, temperature sensors, etc.) for forming images or gathering other information about the work environment in which the manipulator is located. When the manipulator is equipped with a rotatable tool plate, the tool plate can be used to rotate a workpiece or a tool for various purposes including drilling, screw driving, fastening, milling, deburring, and tightening. The manipulator is capable of being miniaturized as well as being made as large as desired, so it can be used in applications ranging from heavy industrial applications down to microassembly or micromachining.

Medical Applications

The end platform of a parallel manipulator according to the present invention can be used to support a medical device, such as a diagnostic device or a surgical tool. Because the links and the end platform can be made extremely small, the manipulator can be used either for surgery through a large surgical opening or for endosurgery through a small surgical opening or body orifice. Because the end platform is capable of being manipulated with high accuracy and dexterity and can provide force feedback to the user, the parallel manipulator is particularly suitable for use in surgery by remote control. The ability of the manipulator to adjust the position of the end platform with a resolution on the order of microns makes the manipulator highly suitable for medical applications requiring precise, fine motions, and particularly for microsurgery performed with the aid of a microscope, including eye surgery, ear, nose and throat surgery, neurosurgery, and micro-hand or micro-orthopedic surgery.

Support Device

Because of its stiffness and ability to dynamically adjust the position of a load, the parallel manipulator can be used as a general purpose support. For example, it can be used to support a camera, a surveying instrument, or a telescope.

Control Device

A parallel manipulator according to the present invention can be used as a master control device with up to six or more degrees of freedom in a master-slave system. Instead of the end platform being used to support a load, the end platform or a handle attached to the end platform can be grasped by a user who manipulates the end platform like a joy stick in a desired manner. The movement of the ends of the links remote from the end platform or changes in the lengths of the links resulting from the movement of the end platform can be sensed to determine the movement of the end platform of the master, and commands for controlling the slave manipulator can be generated based on the sensed movement of the master. A parallel manipulator according to the present invention is particularly suitable as a master control device when the slave device which is to be controlled is another parallel manipulator according to the present invention.

Construction and Maintenance

A parallel manipulator according to the present invention can be used in a manner similar to a conventional crane or “cherry picker” to support equipment, materials, or workers.

### BRIEF DESCRIPTION OF THE DRAWINGS

FIG. 1 is a perspective view of an exemplary parallel manipulator constructed in accordance with the teachings of the present invention.

FIG. 2 is a side elevation view of the parallel manipulator of FIG. 1 showing the end platform in a completely retracted position.

FIG. 3 is a side elevation view of the parallel manipulator of FIG. 1 showing the end platform in a fully extended position.

FIG. 4 is a perspective view of an alternative embodiment of the present invention in which the parallel manipulator of FIG. 1 is mounted on a Stewart platform.

FIG. 5 is a schematic diagram of an embodiment of the present invention in which a controller and haptic interface are provided to control movement of the parallel manipulator of FIG. 1.

### DETAILED DESCRIPTION OF THE INVENTION

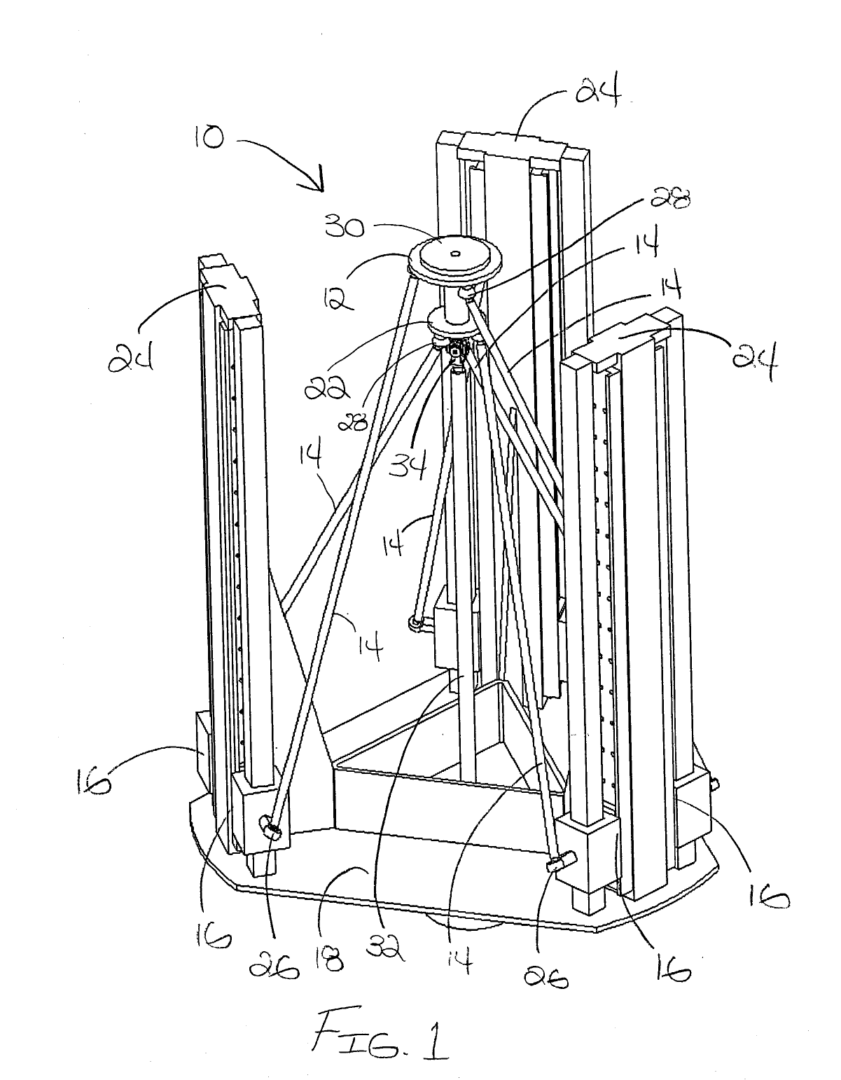

Referring now more particularly to FIGS. 1-3 of the drawings there is shown an illustrative embodiment of a parallel manipulator 10 constructed in accordance with the present invention. The illustrated manipulator 10 includes an end platform 12 which can be used to support and manipulate a load, such as a tool, a sensor, a workpiece, or any other member which it is desired to support and manipulate in space. The manipulator 10 further includes a plurality of links 14, each of which has an associated actuator 16. As will be described in greater detail below, through operation of the actuators 16, the links 14 can support and move the end platform 12 with six or more degrees of freedom.

In the illustrated embodiment, the end platform 12 is generally disk-shaped, but it can have any shape suited to the equipment which it needs to support or the shape of the space in which it is to be manipulated, such as polygonal or a combination of polygonal and curved shapes. Likewise, while the illustrated end platform 12 has an upper surface which is substantially flat, it may be convex, concave, stepped, or otherwise deviate from a planar shape. As will be appreciated by those skilled in the art, the end platform 12 can be used to support a variety of tools, sensors, or other objects, depending upon the task which it is to perform, and its shape or other structural features can be selected in accordance with the nature of the object which is to be supported.

The manipulator 10 of the present invention can have various numbers of links 14 depending upon the number of degrees of freedom with which it is desired to manipulate the end platform 12. Typically, as in the illustrated embodiment, the manipulator 10 will have six links 14 so as to enable the end platform 12 to be controlled with six degrees of freedom, but it may have fewer links if a lesser degree of control is desired. It is possible to have more than six links, although having a large number of links will typically increase the complexity of control and possibly reduce the range of movement of the end platform 12 before the links interfere with each other. For simplicity of structure and control, the links 14 will generally be of the same length as each other, but it is also possible for the lengths to vary among the links.

The links 14 are typically rigid members capable of transmitting a compressive load, although some or all of the links 14 may be tension members, such as flexible cables, which only support a tensile load. In the manipulator 10 shown in FIGS. 1-3, the links 14 are of the type referred to as passive links, meaning that the lengths of the links 14 normally remain constant during operation of the manipulator (ignoring changes in length due to stresses and temperature). Movement of the end platform 12 is achieved by translation of both ends of the links 14 rather than by a change in the lengths of the links. However, passive links need not be incapable of changes in length and may include adjusting screws or other mechanisms which enable their lengths to be adjusted. The links 14 may also incorporate shock absorbers or other damping devices for reducing vibrations.

As will be appreciated, the passive links 14 of the illustrated embodiment can be replaced with what are referred to as active links, each of which has an actuator associated with it, by means of which the link can be adjusted in length to adjust the position of the end platform 12. Moreover, a parallel manipulator according to the present invention is not limited to having only active links or only passive links, and two types of links can be employed in a single manipulator. Furthermore, an active link may have its lower end movably supported, in which case it can function as a hybrid of an active link and a passive link.

Passive links, however, frequently have a number of advantages over active links. For example, passive links can generally be smaller in diameter than active links, so a greater range of movement is possible before interference between adjoining links occurs. In addition, passive links are easier to miniaturize and can be designed to have a high stiffness more readily than an active link. A particularly important advantage of passive links over active links is that the moving mass of a parallel manipulator with passive links can be much less than that of a parallel manipulator of the same size with active links. As a result, the inertia of the parallel manipulator as a whole is much lower, enabling more rapid changes in direction of movement. A lower inertia also increases safety, permits more accurate control of force and position, and results in a higher mechanical bandwidth.

When the manipulator is to be used for high precision manipulation, such as in surgery, in high precision machining, or in the assembly of fine manufactured parts, the links 14 are preferably as stiff as possible to give the manipulator a high resonant frequency and a high mechanical bandwidth. At the same time, the links 14 are preferably as light as possible to give the manipulator a very low inertia. Thus, for such applications, materials having a high ratio of stiffness to density are particularly suitable for use in forming the links 14. One example of such a material is AlBeMet, which is a trademark for a powder metal material including powders of aluminum and beryllium. AlBeMet is available from Brush Wellman of Elmore, Ohio. Other examples of materials which are suitable when a high stiffness to density ratio is desired for the links 14 are carbon fiber composites, magnesium alloys, and aluminum alloys. However, the links 14 are by no means restricted to being formed of these materials and can be selected based on the physical properties desired for the particular application.

By translating the links 14 via their associated actuators 16, the position and/or orientation of the end platform 12 can be changed as desired. The actuators 16 are supported on a base 18 which maintains the spacing between the actuators. For simplicity, in the illustrated embodiment, each actuator 16 acts along a linear path parallel to a common axis. However, the paths of movement of the actuators 16 need not be parallel to each other. Instead, the actuators 16 can act on the lower ends of the links 14 in any direction which will produce a desired movement of the upper ends of the links. In the illustrated embodiment, linear actuators 16 or motors which act along a linear bearing track are used.

Alternatively, other types of linear actuators 16 can be employed such as rotary motors connected to motion converting mechanisms (such as ball-bearing screws or racks and pinions) for converting rotary to linear motion, and hydraulic or pneumatic cylinders. Non-linear actuators also could be used. Among the various types of actuators, linear electric motors are particularly suitable, especially for applications in which precise control of the end platform is desired. In particular, linear electric motors produce a linear output force which allows the manipulator to be controlled with a high degree of precision. Linear electric motors also have a long range of movement and very low friction. Additional details regarding the advantages, construction and operation of exemplary linear actuators suitable for-use in the present invention are disclosed in commonly assigned U.S. Pat. No. 6,330,837.

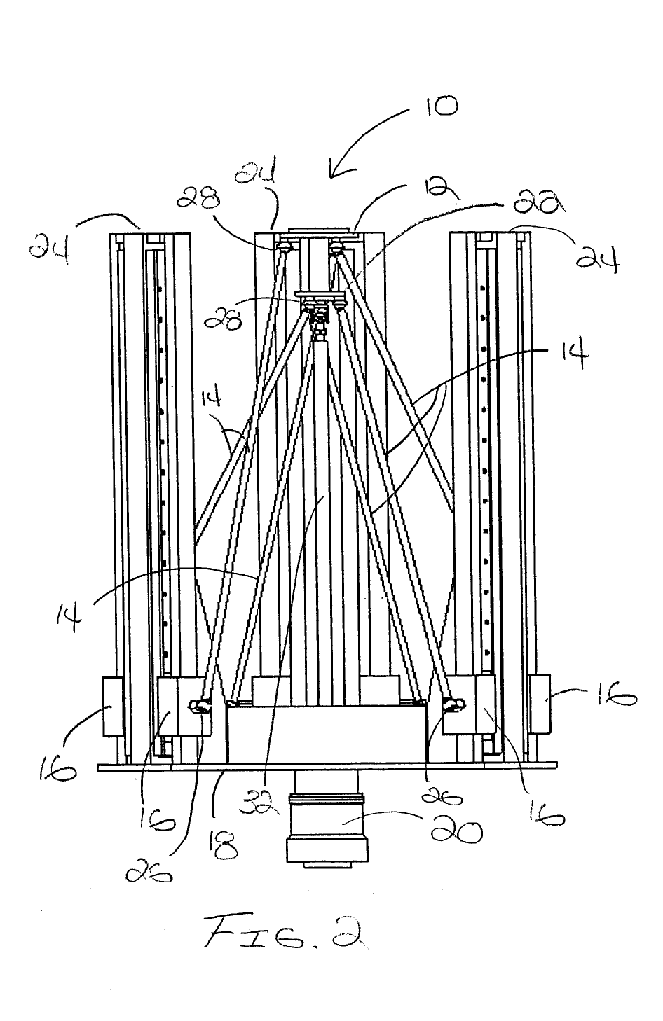

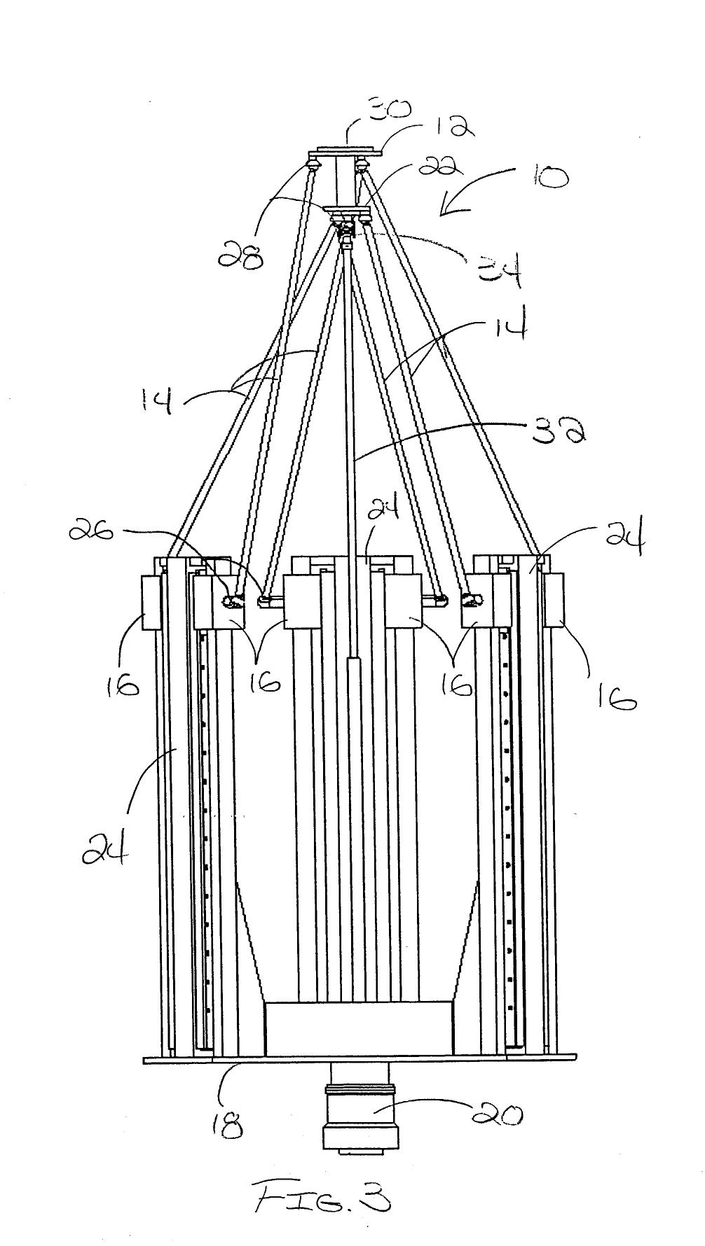

As noted above, in the illustrated embodiment, the manipulator 10 consists of a six degree of freedom end platform 12 driven by six linear actuators 16 through six links 14. As described below, the manipulator 10 includes a seventh rotary actuator or motor 20 (see, e.g., FIGS. 2 and 3) that drives a rotatable tool plate 30 (see FIG. 1) in a plane parallel to the end platform 12. A seventh tool roll axis that moves with the end platform, such as is provided by the rotatable tool plate 30, is desirable because it facilitates a number of industrial assembly and fabrication tasks. Since the manipulator includes a tool roll axis, the end platform 12 really only needs to be positioned in five degrees of freedom. The sixth degree of freedom is still useful for avoiding contact between adjacent links or joints in extreme manipulator positions by rotating the platform 12 to a more desirable orientation.

One way in which the linear actuators can be arranged is in a uniformly symmetrical arrangement with each linear actuator being spaced 60 degrees apart around a central axis for the machine. This is useful to make for even force output in all six degrees of freedom. The links can then be arranged such that pairs of the links cross each other. To allow the links to pass beside one another, they may have to be curved. Crossing the links improves the ability of the platform to generate a torque around the longitudinal axis of the manipulator. However, since the manipulator already includes a seventh tool roll axis, the crossing of the links is an unnecessary complication that limits the overall workspace. Additionally, curved links tend to be more flexible during applied load conditions than straight links of the same weight.

Thus, in accordance an important aspect of the present invention, the links 14 are arranged in such a manner to expand the workspace volume potential as compared to a manipulator using a crossed-link arrangement while enhancing dexterity, improving precision under load and providing a manipulator that is less prone to link interference. To this end, the links 14 are separated spatially along the longitudinal axis of the manipulator 10 in order to eliminate the need to cross the links or to use curved links. In particular, the six links 14 used in the illustrated manipulator 10 are arranged so that three links 14 are connected to the end platform 12 spaced at 120 degree intervals. The other three links 14 are connected to an intermediate platform 22 that is parallel and, in this case, spaced a distance below the end platform 12. The links 14 in this second set are also spaced at 120 degree intervals. This arrangement of the links 14 provides a manipulator 10 that has six degrees of freedom, but is optimized to provide force in only five degrees of freedom. Using spatially separated straight links 14 allows the manipulator 10 to be more rigid for a given mass, and reduces the need to run collision avoidance computations for links and joints in many areas of the workspace.

As will be appreciated, while in the illustrated embodiment, the intermediate platform 22 is smaller than the end platform 12, such a size relationship is not necessary. Moreover, the center of the intermediate platform 22 need not be located directly below the center of the end platform 12 as in the illustrated embodiment. The manipulator 10 can also be adapted such that the distance between the intermediate 22 and end platforms 12 is variable.

The base 18 of the manipulator 10 includes, in this instance, three posts 24 that project upward toward the end platform 12 in a direction perpendicular to the base plane. The three posts 24 are oriented at 120 degree intervals around the circumference of a circle that is centered on the longitudinal axis of the manipulator 10. However, the posts 24 are arranged in this manner only for symmetry reasons, and this arrangement is not a necessary part of the present invention. In this case, the linear actuators 16 are arranged in pairs with two linear actuators 16 being attached to each post 24. Within each pair of linear actuators 16, one actuator 16 is attached via a straight link 14 to the end platform 12 and one actuator 16 is connected via a straight link 14 to the intermediate platform 22. The linear actuators 16 are grouped into pairs for mechanical and accessibility reasons and their arrangement does not relate to any other operational parameter of the design.

The ends of each link 14 are equipped with joints which enable each end to pivot with multiple degrees of freedom with respect to a member to which the link is connected during the operation of the manipulator. Various types of rotatable joints can be used for this purpose, such as universal joints (Hooke's joints, etc.) or spherical joints (ball and socket joints, etc.). In the illustrated embodiment, each of the six links 14 is at attached at its lower end 26 to its respective linear actuator 16 via a joint providing three degrees of rotary freedom. In the illustrated embodiment, because of the physical size of the actuator posts 24, the attachment points of the lower ends 26 of the links 14 are spaced on radial vectors that are between 5 and 60 degrees apart. The upper end 28 of the links 14 are attached to either the end platform 12 or the intermediate platform 22 via joints having two rotary degrees of freedom. The attachment points for the upper ends 28 of the links are spaced at 120 degrees around each platform, but the phasing of the angular relationship between the end and intermediate platforms 22 is variable. In this instance, the optimum phasing angle is near 160 degrees. This can be defined as the angle between the attachment points of any set of links 14 from one linear actuator 16 pair. The radial attachment for the pair would be defined by vectors that radiate at nearly 160 degrees to one another. The optimum angle is between 0 and 180 degrees and will be selected for dexterity and link interference optimization.

While the posts 24 are generally located on a circle, the linear actuators 16 are not necessarily oriented on the same circle. In particular, the linear actuators 16 can be arranged at an optimum angle to the tangent of the circle defined by the centers of posts 24 that allows for the best workspace volume and dexterity. To improve the dexterity and workspace volume of the manipulator 10, the linear actuators 16 in each pair may be offset from each other such that the linear actuators 16 connected to the end platform 12 are offset upward away from the base 18. Additionally, the linear actuators 16 connected to the intermediate platform 22 can also be arranged at a smaller radial distance from the longitudinal axis of the manipulator 10 than the actuators connected to the end platform.

As mentioned above, to provide any desired degree of rotation of a tool or the like supported on the end platform 12, in the illustrated embodiment, the end platform 12 is equipped with a rotatable tool plate 30 on which an object can be mounted and which can be continuously rotated with respect to the end platform 12. Since the tool roll plate 30 is rotatably attached to the end platform 12, the tool roll axis changes with the orientation of the moving end platform. The tool roll plate 30 may be equipped with suitable structure, such as screw holes, brackets, or a chuck, by means of which a tool or other object can be secured to the tool plate. Moreover, the tool roll plate 30 may be located anywhere on the end platform 12 and may be rotatably supported by the end platform 12 in any suitable manner.

For rotating the tool roll plate 30, a drive mechanism is provided. The drive mechanism, which in this case comprises a suitable rotary actuator or motor 20, can be mounted on the end platform 12 itself or on the base 18. In the illustrated embodiment, the toll roll actuator 20 is mounted on the base 18 and is connected to the tool plate 30 in a manner which permits the motor to transmit drive torque to the tool plate 30 at any orientation and location of the end platform 12 with respect to the tool roll actuator 20. For example, two universal joints 34 (only the upper joint can be seen in FIGS. 1-3) that are drivingly connected to each other by a shaft 32 can be disposed between the tool roll actuator 20 and the tool roll plate 30. The upper yoke of the upper universal joint 34 can be secured by a shaft to the tool plate 30, while the lower yoke of the lower universal joint is connected to the rotor of the tool roll actuator 20 by a ball spline or any other suitable type of connecting member for transmitting torque while permitting axial movement. The ball spline allows the lower universal joint to undergo axial movement relative to the tool roll actuator 20 so that the actuator can rotate the tool roll plate 30 at varying distances of the tool roll plate 30 from the base 18. Furthermore, the universal joints enable the tool plate 30 to be rotated by the tool roll actuator 20 in any orientation of the end platform 12 with respect to the base 18. In the illustrated embodiment, the bearings and part of the upper universal joint 34 on the tool roll shaft 32 are contained within a tubular structure that connects the end and intermediate platforms 12, 22 and is coaxial with the tool roll axis.

Additional details concerning the construction and operation of a tool roll plate and associated drive mechanism suitable for use in the present invention are disclosed in commonly assigned U.S. Pat. No. 6,330,837.

With this arrangement, the only time that the links 14 are needed to rotate the end platform 12 about an axis perpendicular to the end platform is for collision avoidance. For example, in the illustrated embodiment, the intermediate platform 22 is located inside of a cone defined by the links 14. In some extreme orientations of the end platform 12, the intermediate platform 22 may tend to contact one of the links 14 attached to the end platform. When such a collision is imminent, the links 14 can be used so as to rotate the end platform 12 and thereby select another solution to the positioning problem where the intermediate platform 12 and the link 14 do not touch. This type of calculation is only required for end platform tilt angles of greater than 30 degrees in most of the workspace of the illustrated embodiment.

In order to calculate the position of the end platform 12 at any time, it is desirable to know the position of the lower end 26 of each link 14. The position of the lower end 26 of the link 14 can be sensed directly, but it is generally easier to sense the position of a member connected to the link, such as the moving portion of the linear actuator 16 associated with the link 14. The position of the linear actuator 16 can be sensed by a wide variety of conventional sensing mechanisms which sense the movement or the position mechanically, magnetically, optically, or in another manner, including potentiometers, linearly variably differential transformers, optical encoders, and Hall effect sensors.

For sensing the rotational position of a link 14 about two orthogonal axes, the lower universal joint of the link can be equipped with two rotational position sensors. Like the linear position sensors for the linear actuators 16, the rotational position sensors 160 may have any structure and operate based upon any physical principle.

The manipulator 10 also may be equipped with one or more force sensors for sensing external forces acting on the end platform 12 so that the motions of the end platform can be controlled in accordance with the sensed forces. Force sensors can be disposed in a variety of locations on the manipulator, with the end platform 12 being a particularly suitable location since there the sensors can directly sense the applied forces. For example, a six degree of freedom force-torque transducer can be mounted on the end platform 12 beneath the tool roll plate 30. Force sensors can also be mounted in or on the passive links 14. Additionally, the individual linear actuators 16 can be equipped with force sensors for sensing the forces or torques applied by the actuator so as to enable a determination forces and torques applied to the end platform 12. Of course, any method for measuring forces and/or torques can be used.

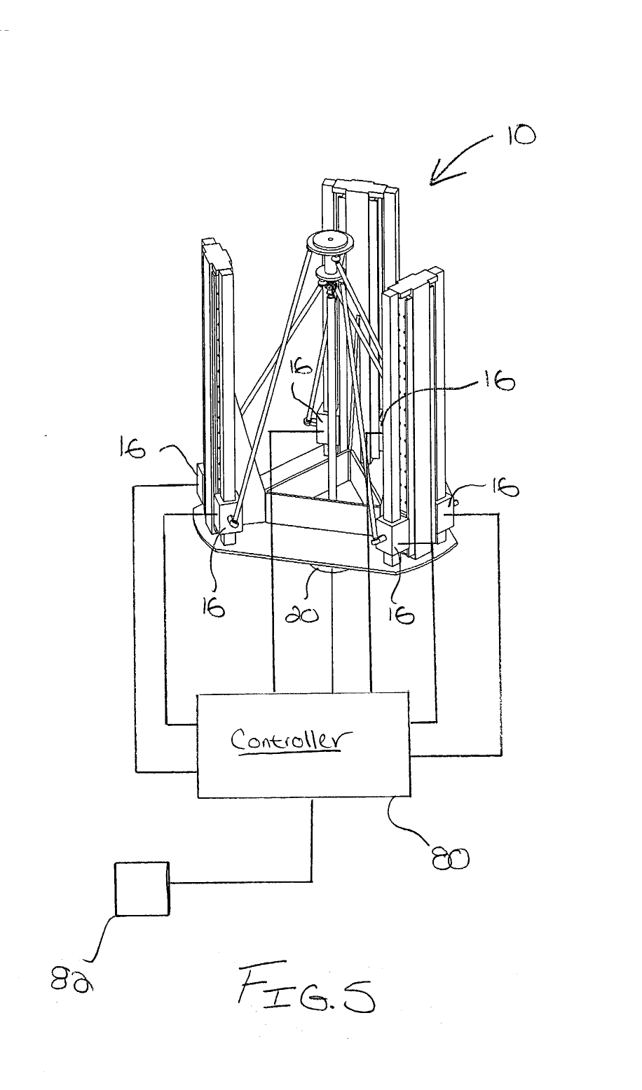

As shown in FIG. 5, a controller 80 can be provided which controls the operation of the linear actuators 16 of the parallel manipulator 10 and the tool roll actuator 20 either autonomously to enable the manipulator to function as an autonomous robot, or based on an input from a suitable input device or haptic interface 82, such as a joy stick, a keyboard, a tape memory or other data storage device which stores instructions for the movement of the end platform 12, a foot pedal, a mouse, a digitizer, a computer glove, or a voice operated controller. The manipulator controller can also receive input signals from the various linear position sensors, the rotational position sensors of the links, the force-torque transducer for the tool roll plate, and any other sensors for sensing some operating parameter of the manipulator, such as a camera for forming an image of the end platform or the work space in which the end platform is operating.

Based on the input from the input devices 82 and the signals from the position sensors and the force/torque transducer(s), the controller 80 can calculate or otherwise determine the position of the end platform 12 and the motion of the individual links 14 required to move the end platform 12 in the desired manner. The controller 80 then provides suitable control signals to drive the appropriate linear actuators 16 or the tool roll actuator 20 to achieve the desired movement of the end platform 12. The controller 80 can control the manipulator 10 in a variety of manners, depending upon the requirements of the task which is to be performed by the manipulator. For example, the controller may perform position control, force control, or a combination of position and force control (hybrid position/force control) of the manipulator. Examples of these and other suitable control methods capable of use in the present invention and algorithms for their implementation are well known in the field of robotics and described in detail in published literature.

In an exemplary embodiment, to limit the amount of moving wiring, the manipulator 10 can be configured such that each linear actuator 16 only has one wire or tube to contend with. With this arrangement, two tubes can be used to route pneumatic power and exhaust to the end platform 12. As few as four wires can also be routed to the end platform 12 such as, for example, one power wire, one power return wire, one control wire and a control return wire. From the end platform 12, power can then be distributed down the links 14 to the moving carriage of the linear actuators 16. Electronics can be provided at this point to read the forces in the links 14 and the distances from the encoders. This information can be transmitted by a modulated laser light from the moving carriage of the actuator 16 to a receiver on the base 18 located below each actuator carriage. A more conventional wiring arrangement can also be used such as by routing control/power wiring and pneumatic lines in parallel with one or more of the links 14 or around the tool roll spline shaft 32 to connect the platform 12 with the manipulator base 18.

Methods of calculating the forward kinematics of a parallel manipulator like that of the present invention (i.e., determining the position and orientation of the end platform relative to the base) are disclosed in commonly assigned U.S. Pat. No. 6,330,837. Algorithms which can be used in the present invention to solve the forward kinematics are well known in the art and are readily derived from basic geometric principles. A detailed discussion of methods of solving for the forward kinematics of a parallel link manipulator with active links can be found in the paper “Optimal Sensor Placement for Forward Kinematics Evaluation of a 6-DOF Parallel Link Manipulator” by Stoughton and Arai (Proceedings of IEEE/RSJ International Workshop on Intelligent Robots and Systems, IROS '91, Volume 2), and the methods disclosed in that paper may also be employed with the present invention, either with active or passive links.

A parallel manipulator according to the present invention is very suitable for use as a master device in a master-slave teleoperated system because it can provide the operator with accurate feedback of the forces being applied to the slave device. The slave device can be any desired mechanism, such as another parallel manipulator according to the present invention. Additional details regarding how a parallel manipulator like that of the present invention can be used in a master-slave-teleoperated system are provided in commonly assigned U.S. Pat. No. 6,330,837.

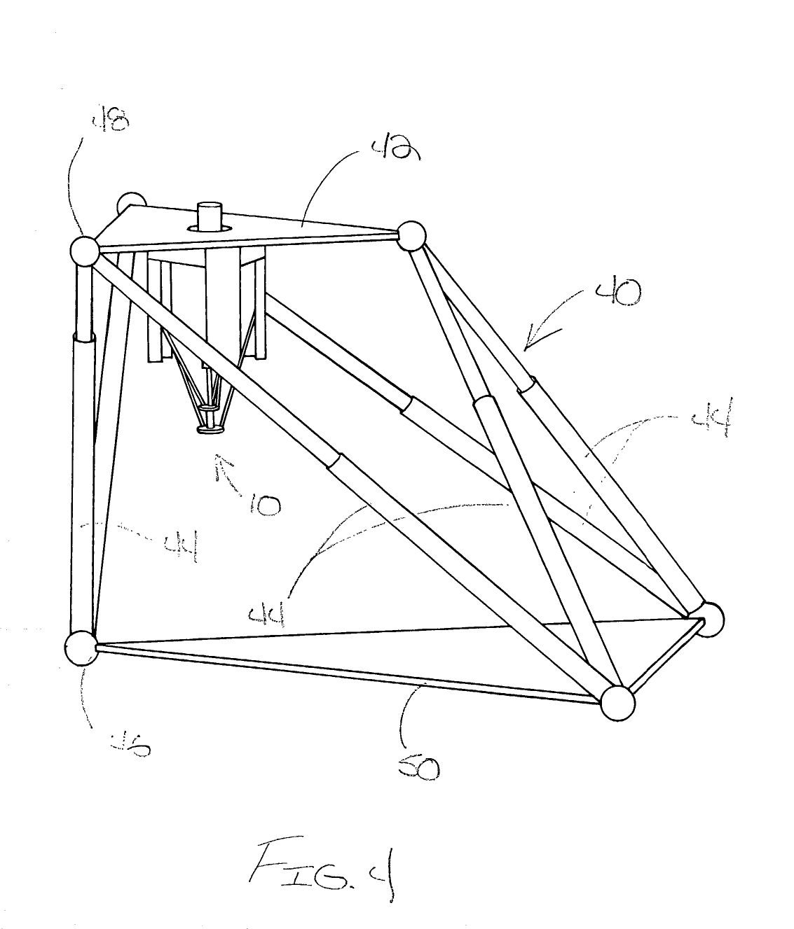

In alternative embodiment, the parallel manipulator 10 of the present invention can be mounted to a Stewart Platform 40 as shown in FIG. 4. The embodiment shown in FIG. 4 provides a hybrid serial/parallel arrangement that can provide enhanced dexterity and accuracy in the workspace volume of the larger Stewart platform 40. As shown in FIG. 4, the typical Stewart platform 40 includes a moving platform 42 supported by a plurality of links 44, in this case six, that can be adjusted in length by actuators to vary the position and orientation of the moving platform 42. At their lower ends 46, the links 44 are connected to a base 50 via joints which are grouped in three pairs. At their upper end 48, the joints connecting the links 44 to the moving platform 42 are also grouped in three pairs. In the illustrated embodiment, the parallel manipulator 10 of FIGS. 1-3 is suspended from a lower surface of the moving platform 42 of the Stewart platform 40. Alternatively, the parallel manipulator 10 can be arranged on the upper surface of the moving platform 42. Moreover, while the illustrated embodiment shows the base 50 of the Stewart platform 40 resting on the ground, it will be understood that the base 50 could be suspended from an overhead structure to provide a completely clear floor area in which to work.

With this embodiment, the Stewart platform 40 can provide precise rigid positioning over a large volume while the parallel manipulator 10 can provide precise rigid positioning combined with force feedback and servoing over a smaller workspace. The parallel manipulator 10 produces the precise delicate movements and the Stewart platform 40 portion of the device moves the parallel manipulator 10 around in the larger workspace. In this way, the precision and other capabilities of the parallel manipulator 10 can be used in a large volume and over larger angular articulation than would be possible by scaling the parallel manipulator 10 without using the additional Stewart platform 40.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A parallel mechanism for manipulating an object in space comprising:
an end platform for supporting an object to be manipulated;
an intermediate platform arranged in spaced relation from the end platform and connected to the end platform by a connecting element;
a plurality of first links each having an end connected to the end platform by a first rotatable joint;
a plurality of second links each having an end connected to the intermediate platform by a second rotatable joint;
a linear actuator associated with each first link and each second link for translating the ends of the first and second links to move the end and intermediate platforms,
wherein each of the first and second joints has a center of rotation, the centers of rotation of the first joints being spaced at substantially equal angular intervals about a first axis, and the centers of rotation of the second joints being spaced at substantially equal angular intervals about a second axis wherein the centers of rotation of the first joints lie in a first plane and the centers of rotation of the second joints lie in a second plane parallel to the first plane.

2. The parallel mechanism of claim 1 wherein each of the first links and each of the second links is substantially straight.

3. The parallel mechanism of claim 1 wherein the first and second axes are coaxial.

4. The parallel mechanism of claim 1 further including a rotatable support member rotatably supported by the end platform.

5. The parallel mechanism of claim 4 further including a drive member for rotating the rotatable support member spaced from the end platform and drivingly connected to the rotatable support member.

6. The parallel mechanism of claim 5 wherein the drive member is connected to the rotatable support member in a manner enabling the drive member to rotate the rotatable support member at varying angles and positions of the end platform relative to the drive member.

7. The parallel mechanism of claim 1 wherein each of the linear actuators is connected to an opposing second end of one of the first or second links.

8. The parallel mechanism of claim 1 further including a base on which each of the linear actuators is supported.

9. The parallel mechanism of claim 8 wherein the base includes a plurality of post elements with a pair of linear actuators being mounted to each post element.

10. The parallel mechanism of claim 9 wherein the pair of linear actuators mounted to each of the post elements includes one linear actuator associated with a first link and one linear actuator associated with a second link.

11. The parallel mechanism of claim 9 wherein the posts are spaced at equal angular intervals about a third axis.

12. The parallel mechanism of claim 11 wherein each of the posts lies on a circle centered on the third axis.

13. The parallel mechanism of claim 8 wherein the base comprises a moving platform supported by a plurality of third links each having a first end connected to the moving platform and further including a plurality of second actuators each associated with a respective one of the plurality of third links for translating the first ends of the third links to move the moving platform.

14. The parallel mechanism of claim 1 wherein the intermediate platform is relatively smaller than the end platform.

15. The parallel mechanism of claim 1 wherein the plurality of first links consists of three first links and the plurality of second links consists of three second links.

16. The parallel mechanism of claim 1 further including a haptic interface which communicates with a controller that directs operation of the linear actuators.

17. The parallel mechanism of claim 16 wherein the haptic interface is adapted to receive manually input position information from an operator and communicate position signals based on the position information to the controller and the controller is adapted to make predetermined adjustments to the position signals prior to directing operation of the linear actuators.

18. The parallel mechanism of claim 1 wherein the first and second axes are coaxial and the centers of rotation of the first joints relative to the first axis are angularly offset from the centers of rotation of the second joints relative to the second axis.

19. The parallel mechanism of claim 1 wherein the linear actuators associated with the first and second links comprises linear motors.

20. A parallel mechanism for manipulating an object in space comprising:
an end platform for supporting an object to be manipulated;
an intermediate platform arranged in spaced relation from the first platform and connected to the first platform by a connecting element;
a plurality of first links each having an end connected to the end platform;
a plurality of second links each having an end connected to the intermediate platform;
a plurality of first actuators with a respective one of the first actuators being associated with each first link and each second link for translating the ends of the first and second links to move the end and intermediate platforms,
a base platform that supports each of the first actuators,
a plurality of third links each having an end connected to the base platform, and
a plurality of second actuators with a respective one of the second actuators being associated with each of the third links for translating the ends of the third links to move the base platform.

21. The parallel mechanism of claim 20 wherein each of the first links and each of the second links is substantially straight.

22. The parallel mechanism of claim 20 further including a rotatable support member rotatably supported by the end platform.

23. The parallel mechanism of claim 22 further including a drive member for rotating the rotatable support member spaced from the end platform and drivingly connected to the rotatable support member.

24. The parallel-mechanism of claim 23 wherein the drive member is connected to the rotatable support member in a manner enabling the drive member to rotate the rotatable support member at varying angles and positions of the end platform relative to the drive member.

25. The parallel mechanism of claim 20 further including a plurality of post elements supported by the base platform with a pair of the first actuators being mounted to each post element.

26. The parallel mechanism of claim 25 wherein the pair of the first actuators mounted to each of the post elements includes one first actuator associated with a first link and one first actuator associated with a second link.

27. The parallel mechanism of claim 26 wherein the posts are spaced at equal angular intervals about a first axis.

28. The parallel mechanism of claim 27 wherein each of the posts lies on a circle centered on the first axis.

29. The parallel mechanism of claim 20 wherein the plurality of first links consists of three first links and the plurality of second links consists of three second links.

30. The parallel mechanism of claim 20 further including a haptic interface which communicates with a controller that directs operation of the first actuators and -the second actuators.

31. The parallel mechanism of claim 30 wherein the haptic interface is adapted to receive manually input position information from an operator and communicate position signals based on the position information to the controller and the controller is adapted to make predetermined adjustments to the position signals prior to directing operation of the first and second actuators.

32. A parallel mechanism for manipulating an object in space comprising:
an end platform for supporting an object to be manipulated;
an intermediate platform arranged in spaced relation from the end platform and connected to the end platform by a connecting element;
a plurality of first links each having an end connected to the end platform;
a plurality of second links each having an end connected to the intermediate platform;
a linear actuator associated with each first link and each second link for translating the ends of the first and second links to move the end and intermediate platforms,
a rotatable support member supported by the end platform and having an axis of rotation fixed with respect to the end platform, and
a drive member for rotating the rotatable support member.

33. The parallel mechanism of claim 32 wherein each of the first links and each of the second links is substantially straight.

34. The parallel mechanism of claim 32 further including a base on which each of the linear actuators is supported.

35. The parallel mechanism of claim 34 wherein the base includes a plurality of post elements with a pair of linear actuators being mounted to each post element.

36. The parallel mechanism of claim 35 wherein the pair of linear actuators mounted to each of the post elements includes one linear actuator associated with a first link and one linear actuator associated with a second link.

37. The parallel mechanism of claim 36 wherein the posts are spaced at equal angular intervals about a third axis.

38. The parallel mechanism of claim 37 wherein each of the posts lies on a circle centered on the third axis.

39. The parallel mechanism of claim 34 wherein the base comprises a moving platform supported by a plurality of third links each having a first end connected to the moving platform and further including a plurality of second actuators each associated with a respective one of the plurality of third links for translating the first ends of the third links to move the moving platform.

40. The parallel mechanism of claim 32 further including a haptic interface which communicates with a controller that directs operation of the linear actuators.

41. The parallel mechanism of claim 40 wherein the haptic interface is adapted to receive manually input position information from an operator and communicate position signals based on the position information to the controller and the controller is adapted to make predetermined adjustments to the position signals prior to directing operation of the linear actuators.

42. The parallel mechanism of claim 32 further wherein the drive member for rotating the rotatable support member is spaced from the end platform and drivingly connected to the rotatable support member.

43. The parallel mechanism of claim 42 wherein the drive member is connected to the rotatable support member in a manner enabling the drive member to rotate the rotatable support member at varying angles and positions of the end platform relative to the drive member.

44. A parallel mechanism for manipulating an object in space comprising:
an end platform for supporting an object to be manipulated;
an intermediate platform arranged in spaced relation from the end platform and connected to the end platform by a connecting element;
a plurality of first links each having an end connected to the end platform;
a plurality of second links each having an end connected to the intermediate platform; and
a linear motor associated with each first link and each second link for translating the ends of the first and second links to move the end and intermediate platforms.

45. The parallel mechanism of claim 44 wherein each of the first links and each of the second links is substantially straight.

46. The parallel mechanism of claim 44 further including a base on which each of the linear motors is supported.

47. The parallel mechanism of claim 46 wherein the base includes a plurality of post elements with a pair of linear motors being mounted to each post element.

48. The parallel mechanism of claim 47 wherein the pair of linear motors mounted to each of the post elements includes one linear motor associated with a first link and one linear motor associated with a second link.

49. The parallel mechanism of claim 48 wherein the posts are spaced at equal angular intervals about a third axis.

50. The parallel mechanism of claim 49 wherein each of the posts lies on a circle centered on the third axis.

51. The parallel mechanism of claim 44 further including a haptic interface which communicates with a controller that directs operation of the linear actuators.

52. The parallel mechanism of claim 51 wherein the haptic interface is adapted to receive manually input position information from an operator and communicate position signals based on the position information to the controller and the controller is adapted to make predetermined adjustments to the position signals prior to directing operation of the linear actuators.
